(19) United States
(12) Patent Application Publication
(10) Pub. No.: US 2019/0377587 A1
(43) Pub. Date: Dec. 12, 2019

(54) SHARING AND EXCHANGING INFORMATION ONBOARD DISPLAYS OR INSTRUMENTS AND AN OFFBOARD DEVICE

(71) Applicant: Honeywell International Inc., Morris Plains, NJ (US)

(72) Inventors: Martin Dostal, Olomouc (CZ); Aaron J. Gannon, Anthem, AZ (US)

(73) Assignee: Honeywell International Inc., Morris Plains, NJ (US)

(21) Appl. No.: 16/005,359

(22) Filed: Jun. 11, 2018

(51) Int. Cl. G06F 9/451; G06F 3/0481; G06K 9/00; G06F 17/30; G06F 9/54

(52) U.S. Cl. CPC G06F 9/451; G06F 3/0481; G06K 2209/01; G06F 17/30256; G06F 9/54; G06K 9/00483

(57) ABSTRACT

A method for interfacing between a first electronic system and a second electronic system is provided. The method comprises: capturing data on a graphical user interface state of the first electronic system using one or more sensors of the second electronic system, wherein at least one type of the data captured with the one or more sensors is image data captured using an optical sensor; recognizing at least one component of the graphical user interface state of the first electronic system, wherein the at least one component of the graphical user interface state further comprises structure and content of the graphical user interface; matching the at least one recognized component with one or more entries in a database on the second electronic system; and performing an action on the second electronic system associated with the matched component.

### BACKGROUND

Conventional systems use portable computing devices (PCD) such as tablets or smartphones in the flight deck. These PCDs are being used as electronic flight bags (EFB) that host documentation or supplementary applications for pre-flight, post-flight or in-flight use. PCD applications further contribute to off-boarding of the functionality that was primarily on-boarded in the integrated displays.

While EFBs are increasingly more powerful devices, options to link or synchronize information between integrated displays or instruments are limited. Further, information uploaded on the flight deck have to meet high levels of certification standards. Moreover, conventional systems require electronic and software interfaces implemented between onboard and off-board devices to share information between them, which is costly to develop.

For the reasons stated above and for the reasons stated below which will become apparent to those skilled in the art upon reading and understanding the specification, there is a need in the art for improved interfaces between electronic systems such as on-board and off-board devices.

### SUMMARY

A method for interfacing between a first electronic system and a second electronic system is provided. The method comprises capturing data on a graphical user interface state of the first electronic system using one or more sensors of the second electronic system, wherein at least one type of the data captured with the one or more sensors is image data captured using an optical sensor. The method further comprises recognizing at least one component of the graphical user interface state of the first electronic system, wherein the at least one component of the graphical user interface state further comprises structure and content of the graphical user interface. The method also comprises matching the at least one recognized component with one or more entries in a database on the second electronic system. Finally, the method comprises performing an action on the second electronic system associated with the matched component.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 illustrates an example of an interfacing system between two electronic systems according to the embodiments described herein.

FIG. 2 describes a flow diagram for an exemplary method for interfacing between a first electronic system and a second electronic system.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments of the present description provide systems and methods for interfacing between two electronic systems. The embodiments described herein use an optical device (such as a rear camera on a portable computing device) and/or an optical character recognition (OCR) sensor to capture an image of at least a part of a display or instrument of an electronic system that is implemented on an on-board system of an aircraft on the aircraft. The captured image by the second system is then recognized and at least one component of the captured image is matched with entries in a database, wherein the database provides the second system with information associated with the matched component of the captured image to determine how to share and link this information between the two electronic systems. Accordingly, the embodiments described herein enable dynamic sharing of information between the two electronic systems.

Further, the interfacing system described herein can be used on legacy avionics, retrofit solutions or mechanical parts of the flight deck. In other words, this interfacing system can be used on existing avionics and instruments of an aircraft. Further, because the method of interfacing is implemented on the off-board system, no cost is incurred in implementing integrated avionics or instruments. Also, an interfacing system implemented on the off-board device does not require high level certification, and the effort of a user (such as, a pilot) in performing a manual search to find correct page and context associated with a component is greatly minimized. Moreover, the interfacing system described herein may be used in accordance with next gen avionics and can also be supported on existing platforms.

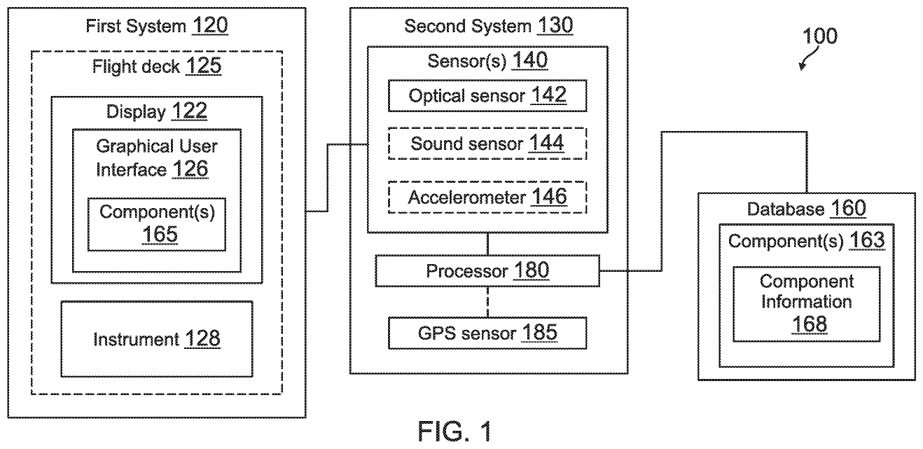

FIG. 1 illustrates an interfacing system 100 that includes at least two electronic systems 120 and 130, wherein the first electronic system 120 is coupled to a second electronic system 130. In exemplary embodiments, the first electronic system is implemented as an on-board avionics system in an aircraft. The first electronic system 120 includes a flight deck 125 including one or more instruments 128. The flight deck 125 further includes a display 122. In exemplary embodiments, display 122 is a primary flight display (PFD). In exemplary embodiments, display 122 implements a graphical user interface 126.

In exemplary embodiments, the second electronic system 130 is implemented on an off-board device. In further exemplary embodiments, the second system 130 is implemented on a portable computing device (PCD), which may be a tablet or a smartphone.

Second electronic system 130 is coupled to one or more sensors 140. In exemplary embodiments, one or more sensors 140 are included in second electronic system 130. In exemplary embodiments, sensor(s) 140 include at least one optical sensor 142. In further exemplary embodiments, optical sensor 142 is configured to capture a single image. In exemplary embodiments, optical sensor 142 is configured to capture a flow of images. In exemplary embodiments, optical sensor 142 is at least one of a camera (such as a rear camera on a tablet) and a video camera. In exemplary embodiments, sensor(s) 140 includes a sound/audio sensor 144. For example, audio sensor 144 can be used to sense a flight deck aural alert. In exemplary embodiments, sensor(s) 140 includes an accelerometer 146. The accelerometer(s) 146 may be used to sense acceleration and deceleration of vehicle including interfacing system 100.

Sensor(s) 140 are coupled to at least one processor 180. In exemplary embodiments, second system 130 includes processor 180. In exemplary embodiments, processor 180 is external to second system 130. Data captured by sensor 140 is sent to processor 180.

In exemplary embodiments, the interfacing application of second system 130 is actively turned on by the user when user wants to obtain relevant information for a component 165 displayed on display 122. In exemplary embodiments, sensor 142 is manually adjusted by the user to capture an image. In exemplary embodiments, when sensor 140 is included on second system 130 (such as, rear camera on a tablet), the user can capture an image including component 165 by manually positioning the device implementing the second system 130 to capture the image including the component.

In exemplary embodiments, optical sensor 142 and/or second system 130 perform passively to capture and process the image respectively. In such an example, sensor 140 is configured to capture images at defined time intervals and second system 130 processes the captured image to determine relevant action that is to be taken. In exemplary embodiments, the image is captured manually by the user to be processed by processor 180.

Processor 180 recognizes at least one component including structure and content of graphical user interface 126 based on the data captured by sensor 140. In exemplary embodiments, the structure and content of graphical user interface 126 includes at least one of shape, color, font, and position of the component. In exemplary embodiments, processor 180 recognizes symbols within the image captured by optical sensor 142 using shapes, color and position of the symbols. Processor 180 further recognizes text by recognizing letters, words or numbers within the text.

For example, a warning, such as “failed generator”, may appear on display 122 indicating generator failure. Further, this warning may appear in amber to indicate that one of the two generators has failed. Alternatively, this message may appear in red to indicate that both generators have failed. In some examples, the size of the font of the message can be larger than normal to indicate urgency. In such an example, processor 180 recognizes the warning “failed generator” and further recognizes the color of the warning, the shape of the font and its location in context with other components that appear on the graphical user interface of display 122.

Processor 180 is further coupled to database 160. In exemplary embodiments, second system 130 includes database 160. In exemplary embodiments, database 160 is external to the second system 130. After recognizing at least one component of graphical user interface 126, processor 180 is further configured to match the recognized component 165 with one or more entries in database 160 on the second system 130. Database 160 determines component 163 that matches with recognized component 165 and provides processor 180 with component information 168 that is associated with component 163. In exemplary embodiments, component information 168 includes one of a checklist or a plan for pilot to implement, a form or worksheet to be completed, etc.

In exemplary embodiments, database 160 includes patterns containing definition of configurations that may be presented on flight deck 125 and captured using optical sensor 142. As described herein, a pattern includes information on components that should be present in an image captured by optical sensor 142 or components that should not be present. The pattern is defined by a set of shapes, colors, positions and text portions. A pattern may further include wildcard areas which are recognized by the system but not restricted in structure or content. For example, “heading time” may be displayed on display 122. In such a case, “heading time” label represents a mandatory area of screen content and the value of heading time represents wildcard area. The value is recognized by processor 180 and used in determining when and what action needs to be performed by the second system 130 and/or the user of second system 130.

In exemplary embodiments, a pattern may be further defined by a set that includes non-optical structure and content. For example, along with the color and text of a warning displayed on display 122, a distinctive alarm may sound to warn the user. In such an example, a pattern is defined by a set of text, color, position of the text and sound. Accordingly, when processor 180 performs matching component 165 with one or more entries in database 160 that includes a similar configuration of text, color, position of the text and sound as recognized component 165.

For example, first system 120 may generate a first alert sound (such as, a single chime) when an amber warning message is displayed on display 122 to indicate caution. Audio sensor 144 senses the sound of the first alert and processor 180 will recognize the warning message and the alarm sound. Processor 180 then performs matching the sound of the first alert, the warning and the amber color of the warning with an entry in database 160 that includes the same sound as the first alert and includes the amber colored warning and the entry is determined as matched component 163. Processor 180 then performs an action on the second system 130 associated with matched component 163. The action performed may include requiring the user to take an action (such as, confirmation that the user has reviewed the warning). If the user does not perform the required action, second system 130 continues to monitor flight deck 125 to determine if an action is taken by the user. The first system 120 may then generate a second different alarm (such as, three chimes in a row) when a red warning is displayed on display 122 to indicate that the warning is more critical than the amber warning. Accordingly, second system 130 continues monitoring the flight deck to assist the user in performing the required actions.

Processor 180 performs an action on the second system 130 associated with matched component(s) 163. In exemplary embodiments, the action performed may include displaying relevant information from an operational manual, linking to an electronic checklist, activating an application, etc. For example, when the warning, such as “failed generator”, is displayed on display 122, processor 180 matches the warning including the color, shape, font and location of the warning with a component in database 122. Database 122 may provide processor 180 with further information 168 with respect to component 163. In such an example, the component information 168 may be a process for the pilot to implement when such a warning is received. In other words, second system 130 is automatically provided with the correct process to implement once it recognizes the warning. Accordingly, in such an example, performing an action on the second system 130 includes displaying a process for the pilot to implement when such a warning is received.

In exemplary embodiments, processor 180 may be able to determine that a warning is imminent and will display the process for the pilot to implement prior to the warning being displayed on display 122. For example, sensor 140 may capture images displaying generator output and recognize variation in voltage. Processor 180 matches this change in the database, determines that the change has likely occurred due to some kind of failure and displays an appropriate plan for the pilot to implement in an event of such a failure.

Further, in exemplary embodiments, performing an action may require a user (such as, flight crew or pilot) to fill out a form in response to receiving a warning. In such an example, processor 180 receives the form from database 160, and proceeds to complete the form automatically. In exemplary embodiments, processor 180 completes the form based on data received from one or more sensors 140 and information received from other sensors internal or external to second system 130.

For example, sensor 140 may capture image data from the display 122 displaying the aircraft that includes first system 120 is flying at an altitude of 30,000 ft. Consequently, processor 180 receives the image data from sensor 140 and determines that the altitude of the aircraft is 30,000 ft. Processor 180 may further receive data from its global positioning system (GPS) sensor 185 with respect to the aircraft's distance from its destination. Similarly, processor 180 may receive and/or determine information with respect to other parameters including but not limited to the aircraft's heading, speed, etc from sensors internal or external to second system 130. Using the information received from various sensors, processor 180 determines the action that is to be taken by the user. In exemplary embodiments, processor 180 may generate a form that is to be completed by the user. In such an example, processor 180 automatically completes the form, partially or completely, using information it has received from various sensors. In exemplary embodiments, processor 180 may require the user to manually input some or all information to complete the form.

In exemplary embodiments, sensor 140 is configured to capture a flow of images. For example, an aircraft cruising at an altitude of 30,000 feet may be cleared to descend to 10,000 ft when it is within a 100 mile radius from the destination. Sensor 140 is configured to continuously capture images at defined time intervals. Based on the images capturing the altitude of the aircraft, processor 180 recognizes that the descent has begun after matching the pattern in the database. Processor 180 may determine that separate actions need to be performed at different times during the descent phase. For example, the pilot may have to perform a different action while the aircraft is above 18,000 ft and below 18,000 ft. Processor 180 is, thus, able to segment component information 168 such that when the pilot is above 18,000 ft, processor 180 displays one plan to be implemented by the pilot and when the pilot is below 18,000 ft, processor 180 displays a different plan to be implemented. Accordingly, processor 180 is configured to recognize the phase that the aircraft is in based on images, text and pattern captured using sensor 140, and is further able to determine the plan that is to be implemented by the user.

In exemplary embodiments, the recognized component 165 by processor 180 may match with two or more entries in database 160. In exemplary embodiments, to resolve the ambiguity, the user may be prompted for input to choose the relevant option from all the matched entries. In exemplary embodiments, the ambiguity is resolved by using any additional available information. In exemplary embodiments, processor 180 automatically uses any additional information that it may have received from sensor 140 or other external sensors. In exemplary embodiments, user is prompted for input to provide additional information to resolve ambiguity between all matched entries and processor 180 uses this additional input to determine the relevant option from all the matched entries as the disambiguated matched component. Processor 180 determines one of the two or more entries as the disambiguated matched component based on at least one of user input or additional information received from internal or external sensors. After resolving the ambiguity, processor 180 performs the action associated with the disambiguated matched component.

In exemplary embodiments, off-board device implementing second system 130 resolves ambiguity between conflicting data on the flight deck. That is, in exemplary embodiments, multiple different sensors can be used to measure a single parameter of the vehicle. The second system 130 receives data from multiple sensors. If data received from a sensor is conflicting with data received from other sensors, processor 180 is further configured to resolve the conflict. Processor 180 can resolve the conflict by determining the correct data to be used based on information that was previously available to processor 180. Processor 180 can also resolve the conflict by prompting for user input after it determines that a conflict exists.

For example, speed of the vehicle can be measured using one or more accelerometers and pitot probes. If an accelerometer provides data different from data provided by the pitot probe, processor 180 may resolve the conflict by determining data from which sensor should be used. Further, in an example, display 122 of the flight deck 125 may display a warning indicating speed miscompare. However, the pilot may fail to notice the warning. In such an example, optical sensor 142 will capture the image of the warning. This image is then processed by processor 180. Processor 180 can use data received from sensors that measure speed to determine data that may be used by the user. Processor 180 may further prompt the user to confirm that the user is aware of the miscompare and/or to determine data that should be used.

In exemplary embodiments, data from other sensors 140 can be used by processor 180 to determine if the pilot is performing the recommended action. For example, first system 120 may generate speed alert aural that is sensed by audio sensor 144. The speed alert aural is an indication for the user to perform an action. Processor 180 may then use accelerometer(s) 146 to sense acceleration and deceleration and compare the data received from accelerometer 146 with speed alert aural sensed using sensor 144 to determine if the user has performed an action is response to the speed alert aural.

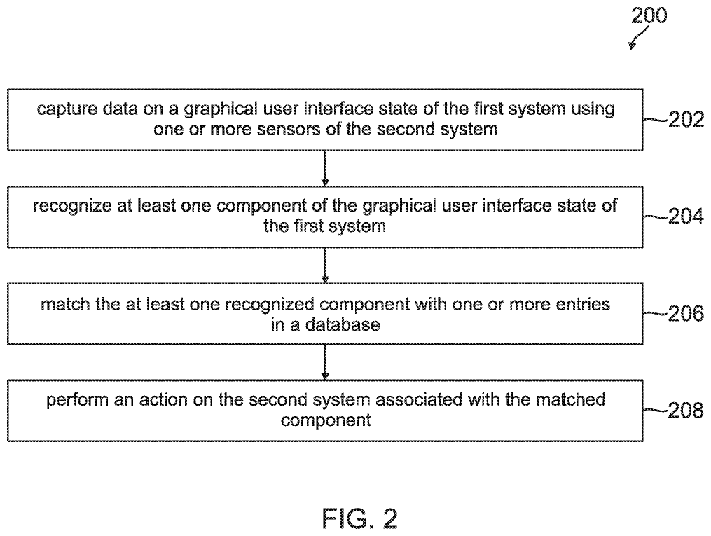

FIG. 2 is a flow diagram of an example method 200 for interfacing between first and second electronic systems, such as systems 120 and 130 of FIG. 1. It should be understood that method 200 may be implemented in conjunction with any of the various embodiments and implementations described in this disclosure above or below. As such, elements of method 200 may be used in conjunction with, in combination with, or substituted for elements of those embodiments. Further, the functions, structures and other description of elements for such embodiments described herein may apply to like named elements of method 200 and vice versa. Further, the example flow diagram is provided as an ordered sequence of steps. Other sequences are possible. Hence, embodiments are not limited to the order of sequence provided in FIG. 2.

Example method 200 begins at block 202 with capturing data on a graphical user interface state of the first system using one or more sensors, such as sensors 140, of the second system. In exemplary embodiments, the first system is implemented as an on-board device of an aircraft and the second system is implemented on an off-board device, such as a portable computing device (PCD).

At least one type of the data captured with the one or more sensors is image data captured using an optical sensor. In exemplary embodiments of the method, the optical sensor is at least one of a camera, a video camera and an optical character recognition (OCR) sensor. In exemplary embodiments, the optical sensor captures a flow of images at defined time intervals. In exemplary embodiments, sensors 140 further include at least one of a sound sensor and an accelerometer. In exemplary embodiments, other types of sensors may be used to measure various parameters of the aircraft including the first system.

Example method 200 then proceeds to block 204 with recognizing at least one component, such as component 165 of the graphical user interface state of the first system. This component of the user interface state further comprises structure and content of the graphical user interface, such as graphical user interface 126. In exemplary embodiments, the structure and content of graphical user interface includes at least one of a shape, color, font and position of the component on the graphical user interface.

Example method 200 then proceeds to block 206 with matching the at least one recognized component with one or more entries in a database, such as database 160. In exemplary embodiments, this database is included on the second system. In exemplary embodiments, one or more entries in the database include patterns having different configurations. A pattern, as described herein, includes a set of shapes, colors, positions, fonts and text portions. In exemplary embodiments, the recognized component is matched with one or more entries, such as matched component 163, having similar configuration to the recognized component.

Finally, example method 200 proceeds to block 208 with performing an action on the second system associated with the matched component, such as component 165. In exemplary embodiments, when the recognized component matches two or more entries in the database, method 200 further includes resolving ambiguity between the two matched entries, such as component 163. In exemplary embodiments, a user is prompted for input to choose a relevant option from all of the matched entries. In exemplary embodiments, method 200 includes receiving additional data and choosing a relevant option from all of the matched entries using additional data. In exemplary embodiments, a user is prompted to input this additional data. In exemplary embodiments, this additional data is received from external sensors or the additional data is already available on the second system.

### Example Embodiments

Example 1 includes a method for interfacing between a first electronic system and a second electronic system, the method comprising: capturing data on a graphical user interface state of the first electronic system using one or more sensors of the second electronic system, wherein at least one type of the data captured with the one or more sensors is image data captured using an optical sensor; recognizing at least one component of the graphical user interface state of the first electronic system, wherein the at least one component of the graphical user interface state further comprises structure and content of the graphical user interface; matching the at least one recognized component with one or more entries in a database on the second electronic system; and performing an action on the second electronic system associated with the matched component.

Example 2 includes the method of Example 1, wherein capturing data on graphical user interface state of the first electronic system further comprises using at least one of a sound sensor and an accelerometer.

Example 3 includes the method of any of Examples 1-2, wherein the image data captured using an optical sensor is a flow of images.

Example 4 includes the method of any of Examples 1-3, wherein the optical sensor is at least one of a camera, a video camera and an optical character recognition (OCR) sensor.

Example 5 includes the method of any of Examples 1-4, wherein the structure and content of the graphical user interface further comprises at least one of shape, color, font, position, and text portion of the component on the graphical user interface in the image data captured using the optical sensor.

Example 6 includes the method of Example 5, wherein matching the at least one recognized component with one or more entries in a database on the second electronic system further comprises matching the at least one recognized component with a set of shapes, colors, positions, fonts and text portions having a similar configuration as the at least one recognized component.

Example 7 includes the method of any of Examples 1-6, wherein the first electronic system comprises an on-board device of an aircraft, and wherein the second electronic system comprises an off-board device.

Example 8 includes the method of Example 7, wherein the off-board device is a portable computing device.

Example 9 includes the method of any of Examples 1-8, wherein when the recognized component matches two or more entries in the database, performing an action on the second electronic system associated with the matched component further comprises: resolving ambiguity between the two or more entries in the database to determine a disambiguated matched component by at least one of: prompting for user input to determine one of the two or more entries in the database as the disambiguated matched component; and automatically determining one of the two or more entries in the database as the disambiguated matched component based on additional data on the second electronic system; and performing an action on the second electronic system associated with the matched component.

Example 10 includes the method of Example 9, wherein prompting for user input further comprises at least one of: prompting for user input to provide additional data such that the processor is able to determine one of the two or more entries in the database based on the received additional data; and prompting for user input to choose one of the two or more matched entries as the matched component.

Example 11 includes a portable computing device for interfacing with an electronic system having a graphical user interface, the portable computing device comprising: one or more sensors configured to capture data on the graphical user interface of the electronic system, wherein at least one of the one or more sensors is an optical sensor configured to capture image data; at least one processor configured to recognize at least one component of the graphical user interface state of the electronic system, wherein the at least one component of the user interface state further comprises structure and content of the graphical user interface; a database coupled to the at least one processor; wherein the processor is further configured to: match the at least one recognized component with one or more entries in the database; and perform an action associated with the matched component.

Example 12 includes the portable computing device of Example 11, wherein at least one of the one or more sensors is at least one of a sound sensor and an accelerometer.

Example 13 includes the portable computing device of any of Examples 11-12, wherein the image data captured using an optical sensor is a flow of images.

Example 14 includes the portable computing device of any of Examples 11-13, wherein the structure and content of the graphical user interface further comprises at least one of shape, color and position of the component on the graphical user interface in the image data captured using the optical sensor.

Example 15 includes the portable computing device of Example 14, wherein the optical sensor is at least one of a camera, a video camera and an optical character recognition (OCR) sensor.

Example 16 includes the portable computing device of any of Examples 11-15, wherein when the recognized component matches two or more entries in the database, prior to performing the action, the at least one processor is further configured to resolve ambiguity based on at least one of user input entered upon prompt and additional data received by the processor.

Example 17 includes the portable computing device of any of Examples 11-16, wherein the electronic system with which the portable computing device is interfacing comprises an on-board device of an aircraft, and wherein the portable computing device is an off-board device.

Example 18 includes a non-transitory computer readable medium storing a program having instructions stored thereon, executable by a processor, to perform a method for interfacing between first and second electronic systems, the method comprising: capturing data on a graphical user interface state of the first electronic system using one or more sensors of the second electronic system, wherein at least one type of the data captured with the one or more sensors is image data captured using an optical sensor; recognizing at least one component of the graphical user interface state of the first electronic system, wherein the at least one component of the user interface state further comprises structure and content of the graphical user interface; matching the at least one recognized component with one or more entries in a database on the second electronic system; and performing an action on the second electronic system associated with the matched component.

Example 19 includes the non-transitory computer readable medium of Example 18, wherein when the recognized component matches two or more entries in the database, performing an action on the second electronic system associated with the matched component further comprises: resolving ambiguity between the two or more entries in the database by at least one of: prompting for user input to determine one of the two or more entries in the database as the matched component; and automatically determining one of the two or more entries in the database as the matched component based on additional data on the second electronic system; and performing an action on the second electronic system associated with the matched component.

Example 20 includes the non-transitory computer readable medium of any of Examples 18-19, wherein the structure and content of the graphical user interface further comprises at least one of shape, color, font, position, and text portion of the component on the graphical user interface in the image data captured using the optical sensor; and matching the at least one recognized component with one or more entries in a database on the second electronic system further comprises matching the at least one recognized component with a set of shapes, colors, positions, fonts and text portions having a similar configuration as the at least one recognized component.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the presented embodiments. Therefore, it is manifestly intended that embodiments be limited only by the claims and the equivalents thereof.

What is claimed is:

1. A method for interfacing between a first electronic system and a second electronic system, the method comprising:
capturing data on a graphical user interface state of the first electronic system using one or more sensors of the second electronic system, wherein at least one type of the data captured with the one or more sensors is image data captured using an optical sensor;
recognizing at least one component of the graphical user interface state of the first electronic system, wherein the at least one component of the graphical user interface state further comprises structure and content of the graphical user interface;
matching the at least one recognized component with one or more entries in a database on the second electronic system; and
performing an action on the second electronic system associated with the matched component.

2. The method of claim 1, wherein capturing data on graphical user interface state of the first electronic system further comprises using at least one of a sound sensor and an accelerometer.

3. The method of claim 1, wherein the image data captured using an optical sensor is a flow of images.

4. The method of claim 1, wherein the optical sensor is at least one of a camera, a video camera and an optical character recognition (OCR) sensor.

5. The method of claim 1, wherein the structure and content of the graphical user interface further comprises at least one of shape, color, font, position, and text portion of the component on the graphical user interface in the image data captured using the optical sensor.

6. The method of claim 5, wherein matching the at least one recognized component with one or more entries in a database on the second electronic system further comprises matching the at least one recognized component with a set of shapes, colors, positions, fonts and text portions having a similar configuration as the at least one recognized component.

7. The method of claim 1, wherein the first electronic system comprises an on-board device of an aircraft, and wherein the second electronic system comprises an off-board device.

8. The method of claim 7, wherein the off-board device is a portable computing device.

9. The method of claim 1, wherein when the recognized component matches two or more entries in the database, performing an action on the second electronic system associated with the matched component further comprises:
resolving ambiguity between the two or more entries in the database to determine a disambiguated matched component by at least one of:
prompting for user input to determine one of the two or more entries in the database as the disambiguated matched component; and
automatically determining one of the two or more entries in the database as the disambiguated matched component based on additional data on the second electronic system; and
performing an action on the second electronic system associated with the matched component.

10. The method of claim 9, wherein prompting for user input further comprises at least one of:
prompting for user input to provide additional data such that the processor is able to determine one of the two or more entries in the database based on the received additional data; and
prompting for user input to choose one of the two or more matched entries as the matched component.

11. A portable computing device for interfacing with an electronic system having a graphical user interface, the portable computing device comprising:
one or more sensors configured to capture data on the graphical user interface of the electronic system, wherein at least one of the one or more sensors is an optical sensor configured to capture image data;
at least one processor configured to recognize at least one component of the graphical user interface state of the electronic system, wherein the at least one component of the user interface state further comprises structure and content of the graphical user interface;
a database coupled to the at least one processor;
wherein the processor is further configured to:
match the at least one recognized component with one or more entries in the database; and
perform an action associated with the matched component.

12. The portable computing device of claim 11, wherein at least one of the one or more sensors is at least one of a sound sensor and an accelerometer.

13. The portable computing device of claim 11, wherein the image data captured using an optical sensor is a flow of images.

14. The portable computing device of claim 11, wherein the structure and content of the graphical user interface further comprises at least one of shape, color and position of the component on the graphical user interface in the image data captured using the optical sensor.

15. The portable computing device of claim 14, wherein the optical sensor is at least one of a camera, a video camera and an optical character recognition (OCR) sensor.

16. The portable computing device of claim 11, wherein when the recognized component matches two or more entries in the database, prior to performing the action, the at least one processor is further configured to resolve ambiguity based on at least one of user input entered upon prompt and additional data received by the processor.

17. The portable computing device of claim 11, wherein the electronic system with which the portable computing device is interfacing comprises an on-board device of an aircraft, and wherein the portable computing device is an off-board device.

18. A non-transitory computer readable medium storing a program having instructions stored thereon, executable by a processor, to perform a method for interfacing between first and second electronic systems, the method comprising:
capturing data on a graphical user interface state of the first electronic system using one or more sensors of the second electronic system, wherein at least one type of the data captured with the one or more sensors is image data captured using an optical sensor;
recognizing at least one component of the graphical user interface state of the first electronic system, wherein the at least one component of the user interface state further comprises structure and content of the graphical user interface;
matching the at least one recognized component with one or more entries in a database on the second electronic system; and
performing an action on the second electronic system associated with the matched component.

19. The non-transitory computer readable medium of claim 18, wherein when the recognized component matches two or more entries in the database, performing an action on the second electronic system associated with the matched component further comprises:
resolving ambiguity between the two or more entries in the database by at least one of:
prompting for user input to determine one of the two or more entries in the database as the matched component; and
automatically determining one of the two or more entries in the database as the matched component based on additional data on the second electronic system; and
performing an action on the second electronic system associated with the matched component.

20. The non-transitory computer readable medium of claim 18, wherein
the structure and content of the graphical user interface further comprises at least one of shape, color, font, position, and text portion of the component on the graphical user interface in the image data captured using the optical sensor; and
matching the at least one recognized component with one or more entries in a database on the second electronic system further comprises matching the at least one recognized component with a set of shapes, colors, positions, fonts and text portions having a similar configuration as the at least one recognized component.
